(19) United States
(12) Patent Application Publication
(10) Pub. No.: US 2026/0368416 A1
(43) Pub. Date: Nov. 19, 2026

(54) LARGE LANGUAGE MODEL-BASED DOCUMENT GENERATION PIPELINE

(71) Applicant: Microsoft Technology Licensing, LLC, Redmond, WA (US)

(72) Inventors: Sara MALVAR MAUÁ, Brasilia (BR); Ranveer CHANDRA, Kirkland, WA (US); Jessica Kristan WOLK, Seattle, WA (US); Bruno SILVA, Recife (BR); Eduardo Rocha RODRIGUES, São Paulo (BR); Rafael Soares PADILHA, Campinas (BR); Maria Angels DE LUIS BALAGUER, Redmond, WA (US); Leonardo DE OLIVEIRA NUNES, Rio de Janeiro (BR); Roberto DE MOURA ESTEVÃO FILHO, Teresópolis (BR); Alexander Steven CROWN, Bellevue, WA (US); Renato Luiz DE FREITAS CUNHA, São Paulo (BR); Khushboo AGGARWAL, Snoqualmie, WA (US)

(21) Appl. No.: 19/223,860

(22) Filed: May 30, 2025

Related U.S. Application Data
(60) Provisional application No. 63/807,221, filed on May 16, 2025.

(51) Int. Cl. G06F 40/166

(52) U.S. Cl. CPC G06F 40/166

(57) ABSTRACT

Large language model-based document generation includes: identifying, based on document generation instructions, a precedent document and one or more specifications for an output document; generating, based on the precedent document, an outline for the output document, the outline including a plurality of sections; generating an adapted outline by modifying one or more sections of the plurality of sections based on content of the one or more specifications; generating, through a plurality of individual inferencing operations using a tuned artificial intelligence (AI) model, a plurality of content segments each corresponding to a distinct section of the adapted outline, wherein each content segment is generated in an individual inferencing operation based on content of the one or more specifications that is specific to that distinct section; and generating the output document by arranging the plurality of content segments according to a structure defined by the adapted outline.

### BACKGROUND

Recently, large language models (LLMs) have been increasingly applied to document generation tasks such as technical manuals, legal contracts, and business reports. These models are typically trained on large, general-purpose datasets drawn from publicly available sources. As a result, while LLMs are effective at producing fluent and well-structured text, they often lack alignment with tenant-specific data, including proprietary terminology, preferred styles, or domain-specific conventions. This limits their ability to generate documents that accurately reflect the unique requirements, context, and language of a particular enterprise or user environment. Further, the generation of long documents is hindered by the model's context window size and other factors, leading to a degradation of the coherency and relevancy of the generated content.

### SUMMARY

According to aspects of the present disclosure, various methods, apparatus, and products for an LLM-based document generation pipeline are disclosed. In some aspects, a method for an LLM-based document generation pipeline includes: identifying, based on document generation instructions, a precedent document and one or more specifications for an output document. The method also includes generating, based on the precedent document, an outline for the output document, the outline including a plurality of sections. The method also includes generating an adapted outline by modifying one or more sections of the plurality of sections based on content of the one or more specifications. The method also includes generating, through a plurality of individual inferencing operations using the tuned AI model, a plurality of content segments each corresponding to a distinct section of the adapted outline. Each content segment is generated in an individual inferencing operation based on content of the one or more specifications that is specific to that distinct section. The method also includes generating the output document by arranging the plurality of content segments according to a structure defined by the adapted outline.

### BRIEF DESCRIPTION OF DRAWINGS

FIG. 1 sets forth a diagram of an example system for LLM-based document generation pipeline in accordance with some examples.

FIG. 2 sets forth a diagram of another example system for LLM-based document generation pipeline in accordance with some examples.

FIG. 3 sets forth a flow chart illustrating an example method for an LLM-based document generation pipeline in accordance with some examples.

FIG. 4 sets forth a flow chart illustrating an additional example method for an LLM-based document generation pipeline in accordance with some examples.

FIG. 5 sets forth a flow chart illustrating an additional example method for an LLM-based document generation pipeline in accordance with some examples.

FIG. 6 sets forth a flow chart illustrating an additional example method for an LLM-based document generation pipeline in accordance with some examples.

FIG. 7 sets forth a flow chart illustrating an additional example method for an LLM-based document generation pipeline in accordance with some examples.

FIG. 8 sets forth a flow chart illustrating an additional example method for an LLM-based document generation pipeline in accordance with some examples.

FIG. 9 sets forth a flow chart illustrating an additional example method for an LLM-based document generation pipeline in accordance with some examples.

FIG. 10 illustrates an exemplary computing device that may be specifically configured to perform one or more of the processes described in the present disclosure.

FIG. 11 sets forth a block diagram of a cloud service provider service architecture in accordance with some examples of the present disclosure.

### DESCRIPTION

Large Language Models (LLMs) have significant capabilities for generating documents based on reference samples, but there are notable limitations, especially when handling large documents. These limitations are primarily due to context window constraints, fidelity degradation over long generations, and difficulty maintaining internal consistency. For example, the context window size is a constraint that means LLMs can only “see” a limited number of tokens (words and symbols) at a time. If a reference document is large and the goal is to generate a similarly detailed document, the model may not be able to process or retain the entire source and tar-get at once. Further, LLMs tend to drift or lose coherence when generating long documents in a single pass, especially when maintaining logical flow across multiple sections or tracking definitions, terms, or concepts introduced earlier. Sections toward the end may become generic or less relevant. Global consistency may be impacted where the model uses different terminology for the same concept, inconsistently applies parameters, or forgets previously stated constraints or re-use copy from the reference improperly. If poorly guided, an LLM may mimic the style and sur-face structure of the reference document but fail to adapt the core subject matter.

Even when an LLM is provided with a reference document to guide generation, its output is still fundamentally shaped by its pretrained knowledge, which is broad and generalized —not specific to a given tenant's private data (such as, internal documentation, previous contracts, proprietary codebases, organizational writing style, etc.). LLMs are often trained on public or li-censed datasets (like academic papers, open-source code, websites). When a customer provides a single reference document, the LLM may replicate its structure or tone, but its content generation is still biased toward patterns seen in its training data and not toward the full context or norms of that organization. As a result, the output may conflict with internal conventions, terms, or document structures. The generated document may omit domain-specific practices found across the tenant's internal documents but not present in the one reference example. The LLM may intro-duce stylistic or procedural artifacts learned from general data that are inconsistent with tenant documentation.

Thus, even with a reference document, an LLM operates with no awareness of a tenant's broader document history or domain context. Its responses are guided by general training and the immediate prompt and not by the institutional knowledge stored in private document repositories. This can lead to outputs that are stylistically inconsistent, incomplete, or misaligned with enterprise expectations.

Various examples of an LLM-based document generation pipeline in accordance with the present disclosure introduce a tuned LLM that is fine-tuned based on a data repository that is specific to a particular tenant. The examples further introduce an integration of the tuned LLM into the customer's document generation software, such as a word processing application, to provide document generation services that are based on tenant data. Fine-tuning involves retraining a pretrained LLM (for example, GPT) on a set of a tenant's internal documents, such as technical documentation, contracts, support tickets, or emails. For document generation, the tuned LLM can better reflect that tenant's language, structure, and subject matter. The tuned LLM utilizes domain-specific language and terminology, resulting in more natural phrasing and reducing stylistic mismatch between generated content and tenant standards. The LLM learns the tenant's common document formats, processes, constraints, and priorities, thus reducing the need for heavy prompt engineering to enforce layout. Tuning the LLM based on the tenant's data reduces hallucinations by grounding the output in factual patterns from internal documents. The documents generated by the tuned LLM provide a more comprehensive starting point for further addition and revision, with the LLM generated content requiring less manual review and editing because it better matches customer expectations.

Various examples for LLM-based document generation pipeline in accordance with the present disclosure also introduce improved mechanisms for document generation using an LLM. A document is generated through an inferencing pipeline that takes, as inputs, a precedent document and one or more specification documents that provide the details for the document to be generated. Specifically, the inferencing for the document generation is segmented based on an outline that has been adapted from the precedent document using the specifications, which inform the content associated with each section of the outline. The adapted outline defines the logical flow, key topics, and hierarchical relationships among sections, reducing ambiguity in the generation process. This structure and segmentation of the inferencing operations helps the tuned AI model maintain coherence, ensure coverage of required content, and preserve consistency in tone, terminology, and formatting across sections.

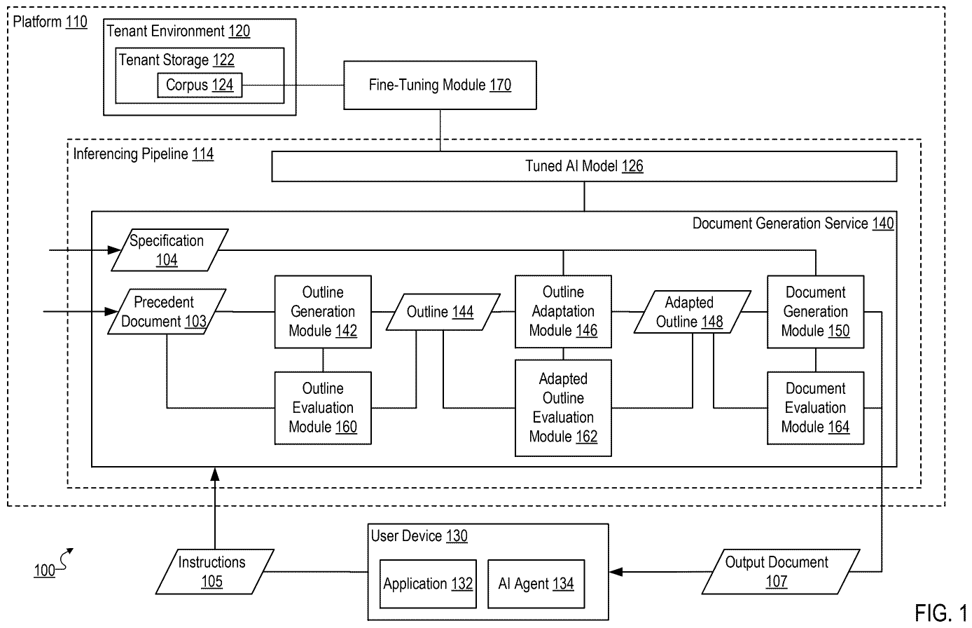

For further explanation, FIG. 1 sets forth a block diagram of an example system 100 for an LLM-based document generation pipeline in accordance with at least one embodiment of the present disclosure. The example system 100 includes a platform 110 that provides AI-driven document generation. The platform 110 can be, for example, a software-as-a-service (SaaS) platform or cloud platform. In some examples, the platform 110 hosts multiple tenant environments. A ‘tenant’ can refer to an individual customer or organization that uses a shared cloud platform or software-as-a-service application. The tenant environment 120 refers to the isolated, self-contained logical partition within a multi-tenant system that belongs to a specific tenant. It includes the resources, configurations, and data that the tenant needs to operate within the shared system in a way that is logically or physically separated from other tenants. In the example of FIG. 1, the tenant environment 120 includes tenant storage 122, which is the private, logically isolated area where the tenant's data is stored and managed. The data stored in the tenant storage 122 can include, for example, documents, files, databases, application configurations and settings, logs, metadata, and the like.

The tenant storage 122 embodies a corpus 124 of documents, files, and other data that is used to fine-tune a base AI model such as an LLM, a small language model (SLM), a model that can interpret and create content across multiple modalities including natural language text such as a large multi-modal model (LMM), or another machine learning model, as can be appreciated. In some examples, the base AI model that is used for fine-tuning can be an off-the-shelf or general-purpose model. To that end, the example platform 110 of FIG. 1 includes a tuned AI model 126 that has been fine-tuned using the corpus 124. The corpus 124 can include all or a subset of the data stored in the tenant storage 122. Additional details on the process of fine-tuning a base AI model are provided below. In other examples, the tuned AI model 126 does not use a base AI model; rather, in these examples, the tuned AI model is a custom AI model that is trained specifically for generative applications based on tenant-owned data.

The example system 100 of FIG. 1 includes a user device 130 such as, for example, a lap-top, mobile device, browser, or thin client. For example, the user device 130 may be a computing device that acts as the execution endpoint for interacting with software and storage that is provisioned and delivered via the platform 110. In some examples, the software itself is hosted, maintained, and executed on cloud infrastructure, while the user device provides a runtime interface to access the platform's capabilities through, for example, a web browser, native client, or API consumer. A ‘user’ can refer to is an identity that exists within the context the tenant environment 120, and is governed by that tenant's identity, access, and data policies. The user may represent an individual (for example, an employee, contractor, customer) or a system entity (for example, a service account, delegated application). As such, the user device 130 is a computing device utilized by such a user to access the platform 110. As used herein, ‘user’ can refer collectively to a person or user identity that accesses the platform 110 as well as the user device 130 through which the platform 110 is accessed.

In the example of FIG. 1, the user device 130 executes an application 132 that is provisioned through the platform 110. By way of illustration not limitation, the application 132 may be a word processing application. The user device 130 also executes an AI agent 134 that is an integrated, tenant-aware tool configured to leverage large language models (LLMs) to assist users with natural language interactions and intelligent suggestions, including task automation, content generation, analysis and insights, and question-and-answer capabilities, by understanding the user's intent. In some examples, the AI agent 134 is integrated within the application 132. In other examples, the AI agent 134 is provided through a standalone client or through web-based interfaces. In the examples described herein, the AI agent 134 provides the interface between the user and the document generation service 140.

The document generation service 140, through interaction with the tuned AI model 126 and the tenant storage 122, implements the inferencing pipeline for document generation. In the example of FIG. 1, a user provides instructions 105 for generating an output document 107 to the inferencing pipeline via the AI agent 134. For example, the user may provide the instructions directly within the application 132. In the illustrative case of a word processing application, the prompt to the AI agent 134 may be formulated directly within the word processing application by typing the prompt within a word processing document. In another example, the user can provide the instructions by opening an interface for the AI agent 134. In some examples, the instructions 105 include a natural language, user-provided description of the requirements for the output document 107 to be generated by the document generation service 140. For example, the instructions 105 can include a guided summary of the requirements for the output document 107 such an overview of the content and structure, a use-case or intent for the output document 107, technical details, particular sections that should be included, and so forth. As such, the instructions 105 can be supplied to the AI agent 134 as a prompt. In some examples, an interface for the AI agent 134 allows the user to select a particular AI model to use for the document generation. In some examples, an interface for the AI agent 134 allows the user to select one or more specifications 104 and a precedent document 103 to use for the output document 107. The inferencing pipeline uses, as inputs, the precedent document 103, the specifications 104, and the instructions 105 to generate the output document 107.

In some examples, the one or more specifications 104 provide content details for the output document 107. In this regard, the specifications 104 provide the ground truth for the output document 107. For example, the specifications 104 included in or referenced by the instructions 105 can include a source code file, a presentation or slide deck, term sheets for a legal document, experimental results for a research paper, reporting for a news article, and so forth. These specifications 104 can be stored in tenant storage 122, supplied directly in a prompt, or uploaded through the AI agent 134. In some examples, an interface for the AI agent allows the user to select one or more specifications 104 that include the content details for the output document 107.

In some examples, the instructions 105 can include or identify the precedent document 103, which can include a template, schema, or reference document. In such examples, the prompt to the AI agent 134 may indicate that the output document 107 should resemble the precedent document 103. The precedent document 103 can be a document already stored in the tenant storage 122 or a new document. In some examples, an interface for the AI agent allows the user to select the precedent document 103 for the output document 107.

In some examples, the user may indicate that the target document to be generated by the document generation service 140 should be similar to a reference document. For example, the reference document may be stored in tenant storage 122. This reference document can be a sample document that reflects the desired structure, tone, voice, level of technical depth, and so on. In such examples, the reference document is the precedent document 103 used by the document generation service 140. In other examples, the precedent document 103 can be a template provided or identified by the user. For example, the template may be stored in tenant storage 122. The template can provide the document structure such as layout, headings, boilerplate language, and so forth.

In some examples, the precedent document 103 can be determined by the document generation service 140. For example, the document generation service 140 can identify the precedent document 103 stored in the tenant storage 122 by calculating a similarity value for preexisting documents in the tenant storage 122 in relation to the specifications 104 or a summary of the specifications supplied or identified by the user. The document generation service 140 may compare the specifications 104 or summary of the specifications to other documents within the tenant storage 122 by calculating a similarity value. The document within the tenant storage 122 that has the highest similarity value is then used by the document generation service 140 as the precedent document 103.

In a particular example, the document generation service 140 can be used to generate documentation for a software component based on a precedent document 103. In some examples, the precedent document 103 can be existing documentation for a different software component. For example, an illustrative software system can include a replication agent for replicating data from a local database to cloud-based object storage. Prior to replication, the data undergoes a deduplication process. Given that documentation exists for the replication agent, a user can request the document generation service 140 to generate documentation for the deduplication agent using the documentation for the replication agent as the precedent document 103. In this case, the instructions 105 provided to the document generation service 140 can include a guided summary of the requirements and/or context of the requested document. For example, the guided summary can include instructions to follow the same structure, tone, voice, and level of technical depth as the documentation for precedent document 103, replacing all component-specific content with details relevant to the deduplication agent. For example, the guided summary can include an overview and functional summary of the software component including, for example, key configuration options, input and output definitions, API structure and/or usage examples, error handling functionality, and performance considerations, to name a few. In a particular example, the instructions 105 can include or reference the source code of the deduplication agent, thus allowing the document generation service 140 to autonomously extract component-specific details. For example, the document generation service 140 may use natural language processing and/or abstract syntax tree analysis to determine input and output definitions, API structure, error handling, and so forth. The above examples are illustrative of the types of information that can be included in the instructions 105 such as the guided summary and should not be construed as required or limiting.

In another particular example, the document generation service 140 can be used to generate a research paper based on a precedent document 103. For example, the precedent document 103 can be existing research paper for a different research project. For the purpose of illustration, consider an example where research has resulted in an improved circuit to mitigate against parasitic capacitance in high frequency applications. Given that a research paper exists for a low noise amplifier, a user can request the document generation service 140 to generate a research paper for the new research using the research paper for the low noise amplifier as the precedent document 103. In this case, the instructions 105 provided to the document generation service 140 can include a guided summary of the requirements and/or context of the requested research paper. For example, the guided summary can include instructions to follow the same structure, tone, voice, and level of technical depth as the low noise amplifier paper, replacing all research-specific content with details relevant to the improved circuit. In this example, the guided summary can include a brief background summary and/or the identification of related work, circuit implementation details, methodologies and/or experimental setup, results, conclusions, and so forth. In a particular example, the instructions 105 can include or reference a slide deck for a presentation of the research, thus allowing the document generation service 140 to autonomously extract research-specific details. The above examples are illustrative of the types of information that can be included in the instructions 105 such as the guided summary and should not be construed as required or limiting.

In yet another particular example, the document generation service 140 can be used to generate a legal document based on a precedent document 103. In some examples, the precedent document 103 can be existing legal document of the same type but for a different case. For example, the legal document can be a new contract that is based on a different contract with different terms and parties. In this case, the instructions 105 provided to the document generation service 140 can include a guided summary and/or term sheet for the new contract. For example, the guided summary can include instructions to follow the same structure, tone, voice, and level of depth as the existing contract, replacing all term-specific content with details relevant to the new contract. For example, the instructions 105 can include or reference a term sheet with details such as the parties, declarations, agreements, governing jurisdiction, contract term, termination and breach stipulations, and so forth.

In the example of FIG. 1, the document generation service 140 includes an outline generation module 142 configured to generate an outline 144 for the output document 107 based on the precedent document 103. In some examples, the document generation service 140 employs natural language processing mechanisms to extract an outline 144 by, for example, recognizing section headers, identifying recognizable patterns, detecting semantic signals that imply structure, generalizing headings or domain-specific terminology into a reusable form, and so on. In a particular example, the outline generation module 142 leverages the tuned AI model 126 to assist in the generation of the outline 144 of the precedent document 103. For example, the outline generation module 142 may construct one or more prompts to the tuned AI model 126 using the precedent document, and generate the outline based on the response(s) from the tuned AI model 126. In some examples, the outline 144 generated by the outline generation module 142 is generated in a hierarchical structured format, such as JSON, YAML, or XML, where each section and subsection is represented as a nested structure. This programmatically-structured format enables integration of the outline 144 into the document generation inferencing pipeline.

In some examples, the document generation service 140 can include an outline evaluation module 160 configured to assess the quality of the outline 144 generated by the outline generation module 142. In some examples, the outline evaluation module 160 utilizes a comparison of the outline 144 to the precedent document 103 to determine a quality score. If the quality score is below a threshold, the outline generation module 142 may prompt the tuned AI model 126 to regenerate the outline. In some examples, the outline evaluation module 160 leverages the tuned AI model 126 to perform the comparison and generate the quality score. For example, the outline evaluation module 160 can prompt the tuned AI model 126 to evaluate the outline 144 based on the precedent document 103 and rate the overall coverage, structure, and clarity of the outline.

In the example of FIG. 1, the document generation service 140 also includes an outline adaption module 146 configured to generate an adapted outline 148 by adapting the outline 144 generated by the outline generation module 142 based on data provided through the instructions 105. For example, the outline adaption module 146 can generate the adapted outline 148 based on the outline 144 and the information included in the specification 104. In some examples, the outline adaption module 146 leverages the tuned AI model 126 to determine, based on one or more specifications 104 and/or the instructions 105, which sections of the outline 144 are unnecessary. For example, a ‘results’ section of the outline 144 of the precedent document 103 can be omitted from the adapted outline 148 if no experimental data is present in the specification 104, while a ‘user interface’ section for software component documentation can be omitted where no user interface is present. For a legal document, the outline adaption module 146 can determine to omit a signature block from the adapted outline 148, as this section is not relevant to document generation. In some examples, the outline adaption module 146 leverages the tuned AI model 126 to determine, based on one or more specifications 104 and/or the instructions 105, which sections of the outline 144 are missing. For example, in a legal document, an ‘intellectual property’ section can be added to the adapted outline 148 where a term sheet in the specification 104 discusses intellectual property and no such section existed in the precedent document 103. In some examples, the outline adaption module 146 generates the adapted outline 148 to include a content summary for one or more sections of the outline 144. For example, the content summary can be additional details of the type of content that pertains to a section of the outline 144 based on the specification 104. In some examples, the adapted outline 148 generated by the outline adaption module 146 is generated in a hierarchical structured format, such as JSON, YAML, or XML, where each section and subsection is represented as a nested structure. This programmatically-structured format enables integration of the adapted outline 148 into the document generation inferencing pipeline.

In some examples, the document generation service 140 can include an adapted outline evaluation module 162 configured to assess the quality of the adapted outline 148 generated by the outline adaption module 146 based on the instructions 105. In some examples, the adapted outline evaluation module 162 utilizes a comparison of the adapted outline 148 to the outline 144 to determine a quality score. If the quality score is below a threshold, the outline adaption module 146 may prompt the tuned AI model 126 to regenerate the adapted outline. In some examples, the adapted outline evaluation module 162 leverages the tuned AI model 126 to perform the comparison and generate the quality score. For example, the adapted outline evaluation module 162 can prompt the tuned AI model 126 to evaluate the adapted outline 148 based on the outline 144 and rate the overall coverage, structure, and clarity of the adapted outline 148.

In the example of FIG. 1, the document generation service 140 also includes document generation module 150 configured to generate the output document 107 based on the adapted outline 148, the data in the specifications 104, and the instructions 105. In some examples, the outline adaption module 146 leverages the tuned AI model 126 to generate the output document 107 using the adapted outline 148, the data in the specifications 104, and the instructions 105 through a series of prompts. Rather than prompting the tuned AI model 126 to generate the entire output document, the document generation module 150 prompts the tuned AI model 126 to generate one portion of the output document 107 at a time. For example, the document generation module 150 can prompt the tuned AI model 126 to generate the output document 107 document section by section based on the adapted outline 148 using the structured data included in the adapted outline 148. As the adapted outline 148 includes a summary of the content for each section, the tuned AI model is prompted to generate that section based on the details in the specifications 104 as they pertain to that section. In an illustrative example for a research paper, the document generation module 150 may prompt the tuned AI model 126 to generate only the background section, then separately prompt the tuned AI model 126 to generate the methodologies section, then separately prompt the tuned AI model 126 to generate the experimental results section, and so on. In this way, the document generation service 140 avoids coherence degradation over long generations. As a result, the document generation service 140 maintains consistency, accuracy, and relevance across complex, multi-section documents.

In some examples, the document generation service 140 can include a document evaluation module 164 configured to assess the quality the output document 107 after the complete document is generated. In some examples, the document evaluation module 164 facilitates an evaluation of the output document based on the precedent document 103, the specification 104, and the instructions 105. If the quality score is below a threshold, the document generation module 150 may prompt the tuned AI model 126 to regenerate one or more sections of the output document 107. In some examples, the document evaluation module 164 leverages the tuned AI model 126 to generate the quality score. For example, the document evaluation module 164 can prompt the tuned AI model 126 to evaluate the output document 107 based on the precedent document 103, the specification 104, and the instructions 105, and rate the overall coverage, structure, and clarity of the output document 107. In some examples, the evaluation of the output document 107 is performed as each section of the output document is generated. For example, after prompting the tuned AI model 126 to generate a section of the output document 107 based on the adapted outline 148, the document evaluation module 164 evaluates the generated section.

In some examples, the document generation module 150 inserts a placeholder where document generation failed. For example, the document evaluation module 164 may determine that document generation failed for a particular section by including information that is not present in the specification 104. That is, the tuned AI model 126 may be hallucinating content. The document generation module 150 can prompt the tuned AI model 126 to regenerate that section; however, if regeneration continues to fail, after a particular number of tries the document generation module 150 can instead insert a placeholder in the output document 107 indicating to the user that the section requires human intervention.

In some examples, if a particular section fails regeneration a threshold number of times, the tuned AI model 126 may be retuned using the tenant's corpus along with the failed section. In some examples, the retuning of the tuned AI model 126, may be carried out when a threshold number of sections fails regeneration a threshold number of times. In some examples, the document evaluation model 164 may evaluation smaller portions of the document, such as subsections of sections. In such an example, the document generation module 150 may regenerate a subsection having a quality score below a threshold. Also, in such an example, the document generation module 150 may cause the tuned AI model 126 to be retuned when a particular subsection fails regeneration a threshold number of times, or when a threshold number of subsections fails regeneration a threshold number of times.

As mentioned above, in some examples, the tuned AI model 126 is a model that is trained and/or fine-tuned based on data in the tenant storage 122. In some examples, the tuned AI model 126 is a base model, such as a large language model that is fine-tuned based on the data in the tenant storage 122. To that end, the platform 110 includes a fine-tuning module 170 configured to fine-tune a base language model by supervising a training of the base language model using the tenant-specific and domain specific data in the tenant storage 122. The objective of this fine-tuning process is to adapt the base language model to reflect the stylistic, tonal, and domain-specific characteristics present in the tenant's existing documents. These characteristics can include, but are not limited to, preferred terminology, technical depth, sentence structure, formatting conventions, and overall narrative style. The tenant documents used for fine-tuning can include various types of authored content, such as technical manuals, software documentation, knowledge base articles, or legal documents. These documents are collected from tenant storage 122 and preprocessed for fine-tuning the base language model. For example, preprocessing may include tokenization, normalization, and segmentation into training samples that meet the token length constraints of the underlying model.

In some examples, the fine-tuning module 170 fine-tunes the base language model based on a specific subset of documents within the tenant storage 122. For example, a base language model can be fine-tuned using software documentation, while another instance of the base language model can be fine-tuned using legal documents. As such, although only one tuned AI model 126 is depicted in FIG. 1, the document generation service 140 may employ multiple tuned AI models corresponding to various domain-specific tasks. In the case of document generation, the user may select a tuned AI model that is specific to a particular type of document to be generated, such as software documentation or a legal document.

During the tuning process, the base model learns to predict the next token in each sequence based on preceding context, thereby internalizing the stylistic and structural patterns embedded in the tenant documents used as the training data. In some examples, the fine-tuning process does not utilize labeled input-output pairs, as the training data consists entirely of natural language sequences sampled from the tenant's own documents. In other examples, the fine-tuning process can use input-output pairs, such as an input specification and template paired with a ground-truth final document.

As a result of this fine-tuning process, the language model becomes more adept at generating text that reflects the tenant's established voice and domain norms. For example, when prompted with a task such as generating documentation, summaries, or correspondence, the model is more likely to produce output that aligns with the tenant's technical conventions, linguistic preferences, and organizational style guidelines. This approach enables domain adaptation of general-purpose language models while preserving tenant-specific linguistic characteristics, without requiring manual specification of formatting or structure.

As mentioned above, in some examples the fine-tuning module 170 fine-tunes the base language model using sample inputs and ground truth documents based on those sample inputs. In this example, the fine-tuning module 170 can employ a training dataset that includes sample instances of: a specification containing content for a final document, a precedent document such as a template or reference document, and a ground truth document that is a document derived from the specification and the precedent document. In such examples, the specification contains the factual or semantic information to be expressed, the precedent document specifies the desired structure and formatting of the resulting document, and the ground-truth document represents the final formatted output that combines the content with the structure prescribed by the template. The ground truth document can be, for example, a human authored document, a machine authored document that has been approved by a human, or a machine authored document that has passed an automated quality evaluation.

During fine-tuning based on input-output pairs, the base language model is trained in a supervised manner to generate the ground-truth document when presented with, for example, the corresponding content and template. In some examples, the content and template are tokenized and formatted with semantic markers. The base language model is trained to predict the next token in the output document given this input. The language model can employ an autoregressive transformer architecture and fine-tuning can be performed using a next-token prediction objective given the ground truth document. A loss is computed based on the output tokens and the ground truth document, and the loss is applied back to the base model undergoing the training.

Following fine-tuning, the performance of the model may be evaluated using a combination of automated and manual techniques. Automated metrics may include the Bilingual Evaluation Understudy Score (BLEU), which measures n-gram overlap between generated and reference text; the Recall-Oriented Understudy for Gisting Evaluation (ROUGE), which evaluates recall based on n-gram or sequence matches; the BERTScore metric, which assesses semantic similarity using contextual embeddings from a pretrained Bidirectional Encoder Representations from Transformers (BERT) model; and the Generalized Language Evaluation Understanding (GLEU) metric, which balances precision and recall. In addition, human evaluators may assess the model's output for coherence, fidelity to the template, consistency in formatting, and preservation of meaning.

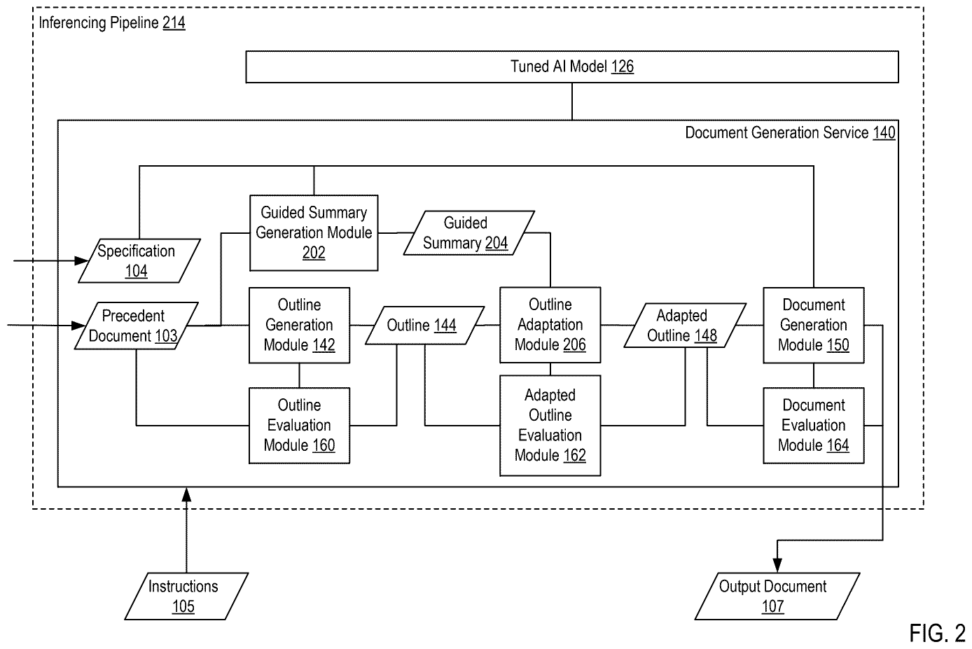

For further explanation, FIG. 2 sets forth a block diagram illustrating a variation of the inferencing pipeline described above with reference to FIG. 1. The inferencing pipeline 214 is similar to the inferencing pipeline 114 of FIG. 1 except that the inferencing pipeline 214 includes a guided summary generation module 202. In inferencing pipeline 214 the guided summary generation module 202 generates a guided summary 204 based on the precedent document 103 and the specifications 104. The guided summary 204 represents a high-level overview of the content contained in the specifications 104. The overview is organized according to the structure of the precedent document. In some examples, the guided summary generation module 202 leverages the tuned AI model 126 or another AI model to generate the guided summary 204. For example, the guided summary generation module 202 can prompt the tuned AI model 126 to generate a summary of the content included in the specifications. The generated summary can be token-limited to prevent coherence degradation associated with a long generation task. The guided summary generation module 202 can also prompt the tuned AI model 126 to organize the generated summary according to the structure of the precedent document 103 to produce the guided summary 204. The guided summary 204 represents a synopsis of both the content and form for the output document 107.

The inferencing pipeline 214 of FIG. 2 also includes an outline adaption module 206 that is similar to the outline adaption module 146 of FIG. 1 except that the outline adaption module 206 of FIG. 2 adapts the outline 144 using the guided summary 204. For example, the outline adaption module 206 can generate the adapted outline 148 based on the outline 144 and the information included in the guided summary 204. In some examples, the outline adaption module 206 leverages the tuned AI model 126 or another AI model to determine, based on the guided summary 204 and/or the instructions 105, which sections of the outline 144 are unnecessary. For example, a ‘results’ section of the outline 144 of the precedent document 103 can be omitted from the adapted outline 148 if no experimental data is mentioned in the guided summary 204, while a ‘user interface’ section for software component documentation can be omitted where no user interface is discussed. In some examples, the outline adaption module 206 leverages the tuned AI model 126 to determine, based on the guided summary 204 and/or the instructions 105, which sections of the outline 144 are missing. For example, in a legal document, an ‘intellectual property’ section can be added to the adapted outline 148 where the guided summary 204 discusses intellectual property and no such section existed in the precedent document 103. In some examples, the outline adaption module 206 generates the adapted outline 148 to include a content summary for one or more sections of the outline 144. For example, the content summary can be additional details of the type of content that pertains to a section of the outline 144 based on the guided summary 204. In some examples, the adapted outline 148 generated by the outline adaption module 206 is generated in a hierarchical structured format, such as JSON, YAML, or XML, where each section and subsection is represented as a nested structure.

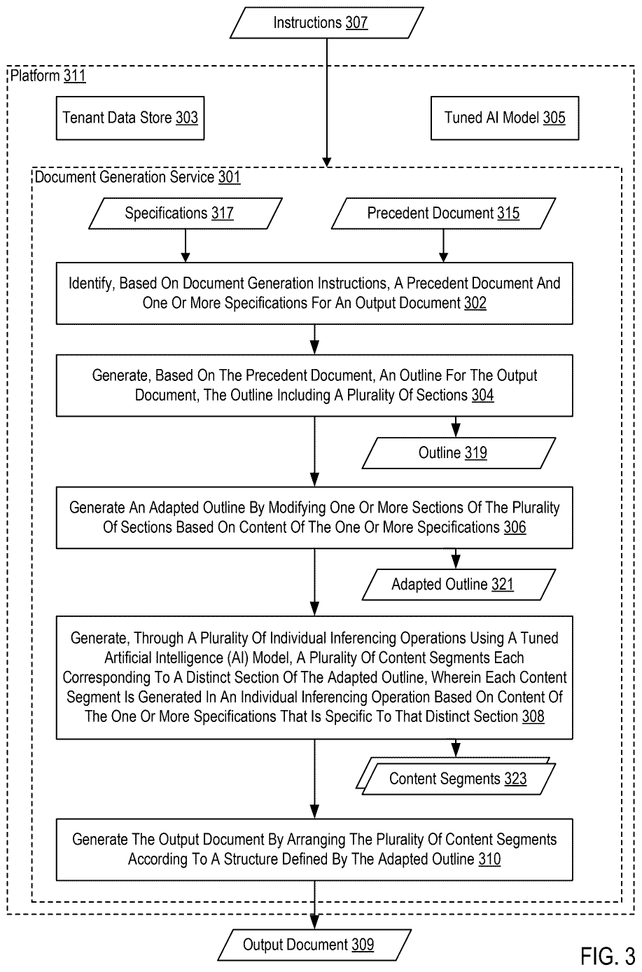

For further explanation, FIG. 3 sets forth a flow chart illustrating an example method for an LLM-based document generation pipeline in accordance with at least one embodiment of the present disclosure. The example of FIG. 3 includes a document generation service 301. In various examples discussed below, the document generation service 301 implements the document generation service 140 of FIG. 1. However, it will be appreciated that the documentation generation service 301 may be implemented differently than the document generation service 140 of FIG. 1, with more or fewer components and a substantially similar functionality, without departing from the principles of the present disclosure. In the example of FIG. 3, the document generation service 301 is hosted within a platform 311. For example, the platform 311 can be a cloud-based platform or SaaS platform, such as the platform 110 of FIG. 1. The platform 311 interacts with a user device (not shown) that can execute one or more applications associated with the platform 311. In the example of FIG. 3, the platform 311 also includes a tenant data store 303. The tenant data store 303 includes data associated with a particular tenant. Further, in this example, a user associated with the user device corresponds to an identity that is associated with that particular tenant. The user device may further execute an AI agent that interacts with the document generation service 301, similar to the AI agent 134 of FIG. 1. In the example of FIG. 3, the platform 311 also includes a tuned AI model 305. The tuned AI model 305 is fine-tuned based on one or more datasets in the tenant data store 303. For example, the tuned AI model 305 can be similar in functionality and characteristics as the tuned AI model 126 of FIG. 1.

The document generation service 301 is configured to receive a user request to generate a document and generate an output document based on the requirements outlined in the user request. To that end, the method of FIG. 3 includes identifying 302, based on document generation instructions 307 received from a user, a precedent document 315 and one or more specifications 317 for an output document 309. In some examples, the document generation instructions 307 includes instructions, such as a prompt to an AI agent, to generate a document based on a particular set of requirements. The one or more specifications 317 include the content to be used in generating the output document 309. In one example, a specification 317 is included within the document generation instructions 307. For example, the specification 317 can be a set of changes to an existing document, where those changes are spelled out in the document generation instructions 307. In another example, the document generation instructions 307 identifies the specification 317 as one or more documents in the tenant data store 303. For example, the specification 317 can be identified by a file name or location specified in the document generation instructions 307.

The precedent document 315 provides the structure for the output document 309, and can also provide an example of the tone, linguistic style, and level of detail for the output document 309. In one example, the precedent document 315 is a template or schema. In another example, the precedent document 315 is a reference document. For example, the reference document can be preexisting document that is used to illustrate the structure, tone, linguistic style, and level of detail for the output document 309. The precedent document 315 can be stored in the tenant data store 303 or can be provided within the document generation instructions 307. In other examples, the precedent document 315 can be identified by the document generation service 301. For example, the document generation service 301 may infer the precedent document 315 to use for generating the output document 309 based on the context of the document generation instructions 307.

The method of FIG. 3 also includes generating 304, based on the precedent document 315, an outline 319 for the output document 309, the outline including a plurality of sections. In some examples, the document generation service 301 generates the outline 319 using natural language processing mechanisms to extract the outline 319 by, for example, recognizing section headers, identifying recognizable patterns, detecting semantic signals that imply structure, generalizing headings or domain-specific terminology into a reusable form, and so on. In a particular example, the document generation service 301 leverages the tuned AI model 305 to assist in the generation of the outline 319 of the precedent document 315. For example, the document generation service 301 may construct one or more prompts to the tuned AI model 305 using the precedent document, and generate the outline based on the response(s) from the tuned AI model 305. The form of the generated outline 319 includes a plurality of sections identified by at least a section title or header, where each section may also include subsections represented by a subsection title or header. In some examples, the outline 319 is generated in a hierarchical structured format, such as JSON, YAML, or XML, where each section and subsection is represented as a nested structure.

The method of FIG. 3 also includes generating 306 an adapted outline 321 by modifying one or more sections of the plurality of sections based on content of the one or more specifications 317. In some examples, the document generation service 301 generates 306 the adapted outline 321 by using the tuned AI model 305 to modify the outline 319 to add or remove sections based on the content of the specifications 317. For example, a ‘results’ section of the outline 144 of the precedent document 103 can be omitted from the adapted outline 148 if no experimental data is present in the specification 104, while a ‘user interface’ section for software component documentation can be added where no user interface section was present in the outline. In some examples, the document generation service 301 generates 306 the adapted outline 321 by using the tuned AI model 305 to modify the outline 319 to include section descriptions based on the content of the specifications 317. In some examples, the document generation service 301 leverages the tuned AI model 305 to determine, based the specifications 317 and/or the document generation instructions 307, which sections of the outline 319 are missing or unnecessary. In some examples, the document generation service 301 generates 306 the adapted outline 321 by modifying the outline 319 to include a content summary for one or more sections of the outline 319. For example, the content summary can be additional details of the type of content that pertains to a section of the outline 319 based on the specification 317. In some examples, the adapted outline 321 generated by the outline adaption module 146 is generated in a hierarchical structured format, such as JSON, YAML, or XML, where each section and subsection is represented as a nested structure.

To avoid coherence degradation associated with long generations, the output document 309 is generated section by section or subsection by subsection. To that end, the method of FIG. 3 also includes generating 308, through a plurality of individual inferencing operations using an AI model 305, a plurality of content segments 323 each corresponding to a distinct section of the adapted outline 321. In some examples, the document generation service 301 generates 308, through the plurality of individual inferencing operations, each content segment 323 by prompting the tuned AI model 305 to generate a content segment 323 based on a particular section of the adapted outline 321 and the document generation instructions 307. The adapted outline 321 provides the context for that particular section, thus facilitating the tuned AI model 305 to identify content in the one or more specifications that is specific to that particular section. After the content segment is generated for that particular section in a one individual inferencing operation, a new inferencing operation invoke with a new prompt to generate another content segment for another section of the outline. This continues until a content segment 323 has been generated for each section or subsection of the adapted outline 321 using content from specification 317 that is relevant to each particular section. In this way, each content segment 323 is generated in an individual inferencing operation based on content of the one or more specifications 317 that is specific to that distinct section. Further, as discussed above, the tuned AI model 305 is fine-tuned based on data in the tenant data store 303, which includes the data associated with the user. As such, in the example of FIG. 3, the tenant data store 303 provides the user data store.

In an illustrative example of a legal document, the adapted outline 321 may include a structure for the legal document in the form of sections and subsections. For example, the adapted outline 321 may include multiple sections corresponding to a preamble to identify parties, a first clause, a second clause, and so forth. For each section and/or subsection, the adapted outline 321 may include a content summary providing context for the type of content that should appear in that section. The specification 317 may be a term sheet for the output legal document. Generation of the output legal document would thus entail the document generation service 301 prompting the tuned AI model 305 to generate a content segment 323 for the preamble section based on the adapted outline 321 and the term sheet. In a separate prompt, the document generation service 301 would prompt the tuned AI model 305 to generate a content segment for the first clause section based on the adapted outline 321 and the term sheet. In a separate prompt, the document generation service 301 would prompt the tuned AI model 305 to generate a content segment for the second clause section based on the adapted outline 321 and the term sheet. This would continue until content segments for each section have been generated.

The method of FIG. 3 also includes generating 310 the output document 309 by arranging the plurality of content segments 323 according to a structure defined by the adapted outline 321. In some examples, the document generation service 301 generates 310 the output document 309 by creating a new document and inserting each generated content segment 323 into the document in the order defined in the adapted outline. In some examples, the output document 309 is a word processing document, however it will be appreciated that the principles of the present disclosure can be applied to any type of document including illustrations and other graphical content.

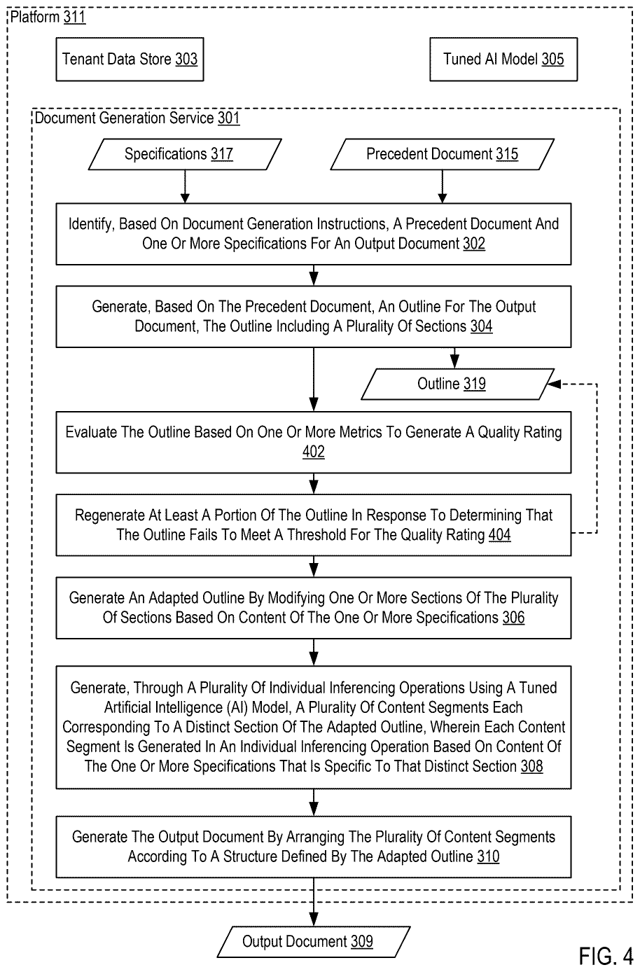

For further explanation, FIG. 4 sets forth another example method for an LLM-based document generation pipeline in accordance with at least one embodiment of the present disclosure. The method of FIG. 4 extends the method of FIG. 3 in that the method of FIG. 4 also includes evaluating 402 the outline based on one or more metrics to generate a quality rating. In the example of FIG. 4, the document generation service 301 is configured to assess the quality of the outline 319 generated by the document generation service 301. In some examples, the document generation service 301 evaluates 402 the outline using a comparison of the outline 319 to the precedent document 315 to determine a quality score based on one or more metrics such as a completeness metric, a structural similarity metric, a semantic similarity metric, a textual similarity metric, and so on. In some examples, the document generation service 301 leverages the tuned AI model 305 to perform the comparison and generate a quality score based on the metrics. For example, the document generation service 301 can prompt the tuned AI model 305 to evaluate the outline 319 based on the precedent document 315 and rate the overall coverage, structure, and clarity of the outline.

The method of FIG. 4 also includes regenerating 404 the outline 319 in response to determining that the outline 319 fails to meet a threshold for the quality rating. For example, the quality rating may be a quality score. In some examples, if the quality score is below a threshold then the document generation service 301 regenerates 404 the outline 319 by prompting the tuned AI model 305 to regenerate the outline. In some examples, the prompt may include a result of the evaluation, such as an indication that a particular section is missing.

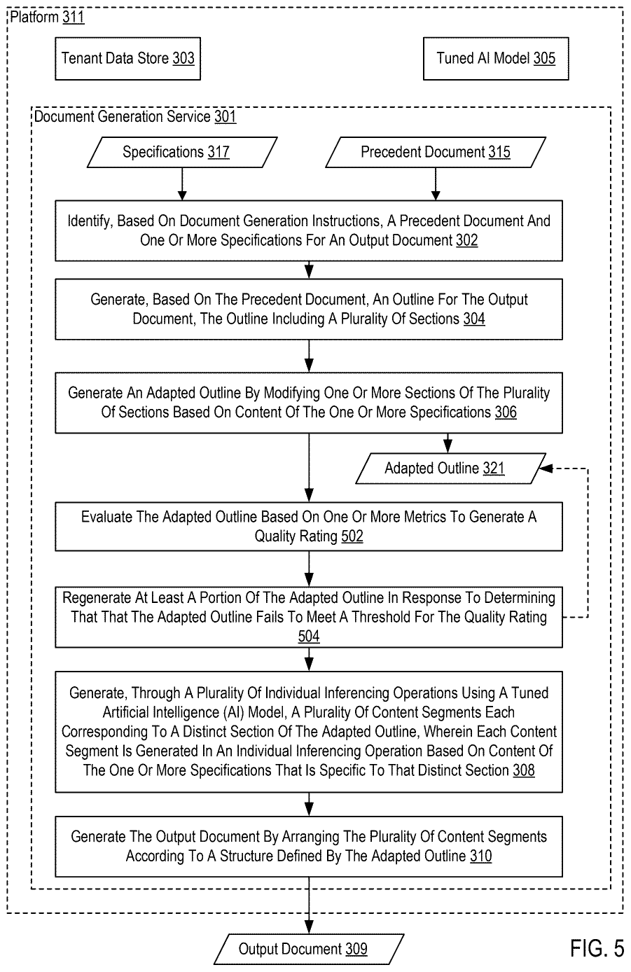

For further explanation, FIG. 5 sets forth another example method for an LLM-based document generation pipeline in accordance with at least one embodiment of the present disclosure. The method of FIG. 5 extends the method of FIG. 3 in that the method of FIG. 5 also includes evaluating 502 the adapted outline 321 based on one or more metrics to generate a quality rating. In the example of FIG. 5, the document generation service 301 is configured to assess the quality of the adapted outline 321 generated by the document generation service 301. In some examples, the document generation service 301 evaluates 502 the adapted outline 321 using a comparison of the adapted outline 321 to the outline 319 to determine a quality score based on one or more metrics such as a completeness metric, a structural similarity metric, a semantic similarity metric, a textual similarity metric, and so on. In some examples, the document generation service 301 leverages the tuned AI model 305 to perform the comparison and generate a quality score based on the metrics. For example, the document generation service 301 can prompt the tuned AI model 305 to evaluate the adapted outline 321 based on the outline 319 and rate the overall coverage, structure, and clarity of the outline.

The method of FIG. 5 also includes regenerating 504 the adapted outline 321 in response to determining that the adapted outline 321 fails to meet a threshold for the quality rating. For example, the quality rating may be a quality score. In some examples, if the quality score is below a threshold then the document generation service 301 regenerates 504 the adapted outline 321 by prompting the tuned AI model 305 to regenerate the adapted outline 321. In some examples, the prompt may include a result of the evaluation, such as an indication that a particular section is missing.

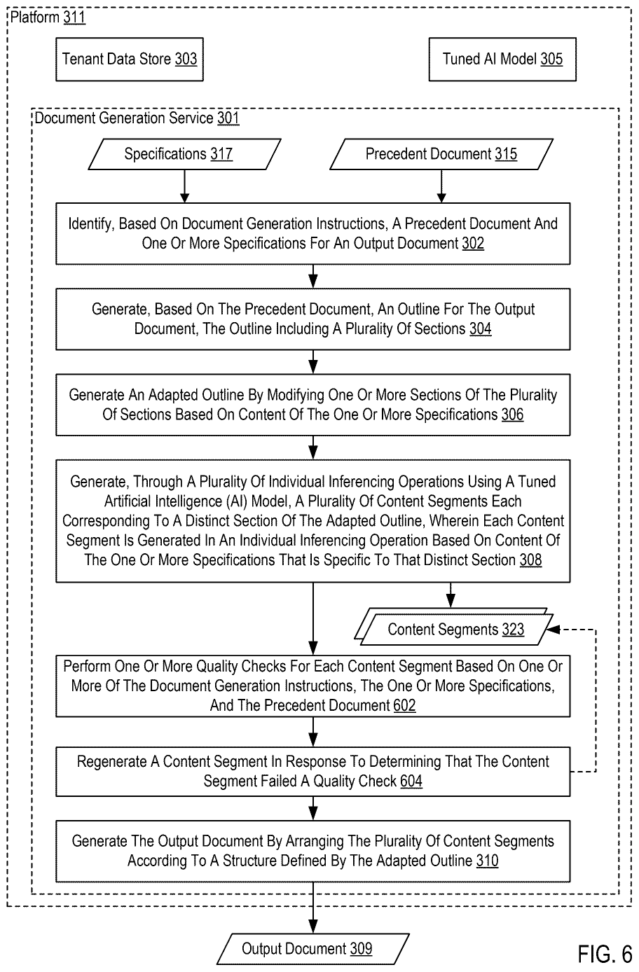

For further explanation, FIG. 6 sets forth another example method for an LLM-based document generation pipeline in accordance with at least one embodiment of the present disclosure. The method of FIG. 6 extends the method of FIG. 3 in that the method of FIG. 6 also includes performing 602 one or more quality checks for each content segment 323 based on one or more of the document generation instructions 307, the one or more specifications 317, and the precedent document 315. In some examples, the document generation service 301 performs 602 a quality check on a content segment by comparing the content segment to the document generation instructions 307 to determine whether the content segment is consistent with a stated goal of the document generation requested by the user. In some examples, the document generation service 301 leverages the tuned AI model 305 to rate the content segment based on the document generation instructions 307. Such a rating can be based on semantic similarity, context, intent, and so on. In some examples, the document generation service 301 can compare the rating generated by the tuned AI model 305 to a threshold to determine whether the content segment passes the quality check.

In some examples, the document generation service 301 performs 602 a quality check on a content segment 323 by comparing the content segment to the one or more specifications 317 to determine whether the content segment is consistent with the details of the specifications 317 and that the tuned AI model 305 did not hallucinate facts, entities, number dates, and so forth when generating the content segment. In some examples, the document generation service 301 leverages the tuned AI model 305 to rate the content segment based on the specification 317. Such a rating can be based on semantic similarity, context, intent, and so on. In some examples, the document generation service 301 can compare the rating generated by the tuned AI model 305 to a threshold to determine whether the content segment passes the quality check. In some examples, the document generation service 301 includes an entity recognition module that extracts entities from the content segment, such as named entities, values, dates, places, and so forth, and compares those extracted entities to the specifications 317 to ensure that the extracted entities are described in the specifications 317. In this way, the document generation service 301 can detect AI model hallucinations that generate content that is unsupported by the specifications 317.

In some examples, the document generation service 301 performs 602 a quality check on a content segment 323 by comparing the content segment to the precedent document 315 to determine whether the content segment is consistent with the form and structure of the precedent document 315, including checking the formal integrity of the content segment to identify, for example, unusual characters or formatting issues. In some examples, performing a quality check on all of the content segments includes quality check of the entire output document 309 to determine whether the output document 309 is missing any portions of content that were identified in the document generation instructions 307, the adapted outline 321, and/or the precedent document 315.

The method of FIG. 6 also includes regenerating 604 a content segment 323 in response to determining that the content segment failed a quality check. In some examples, if the quality rating is below a threshold then the document generation service 301 regenerates 604 the content segment 323 by prompting the tuned AI model 305 to regenerate the content segment 323. In some examples, the prompt may include a result of the evaluation, such as an indication the quality problem.

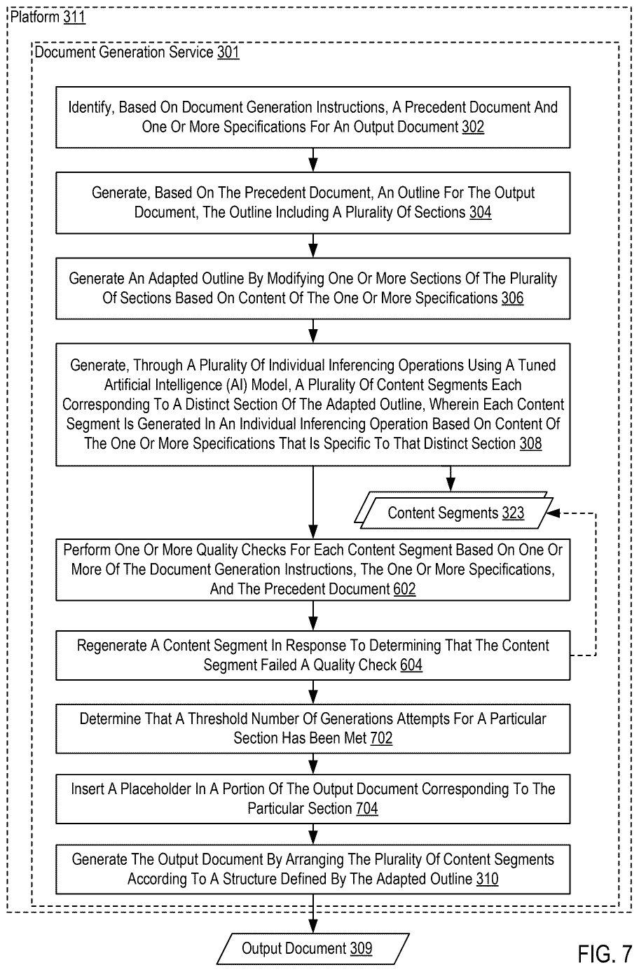

For further explanation, FIG. 7 sets forth another example method for an LLM-based document generation pipeline in accordance with at least one embodiment of the present disclosure. The method of FIG. 7 extends the method of FIG. 6 in that the method of FIG. 7 also includes determining 702 that a threshold number of generations attempts for a particular section has been met if the content segment continues to fail quality checks. For example, the tuned AI model 305 might repeatedly hallucinate party names, generate content that is inconsistent with the document generation instructions 307, or generate generally incoherent content. In some examples, there is a limit to the number of times the document generation service 301 will have the tuned AI model 305 generate a content segment for the same section or subsection. In these examples, the document generation service 301 determines 702 that the threshold number of generation attempts has been met once this limit has been reached. In an illustrative example, if there is a limit of three generation attempts and all three generation attempts have failed a quality check, the document generation service 301 will discontinue content generation attempts for that section or subsection and not attempt a fourth generation. In some examples, repeated failures can lead to retuning the AI model 305 based on the section or subsections have a failed quality score. In some examples, a user can be notified of repeated regeneration failures for a particular section or subsection.

The method of FIG. 7 also includes inserting 704 a placeholder in a portion of the output document 309 corresponding to the particular section. In some examples, in response to detecting that the regeneration limit has been reached for a particular content segment, the document generation service 301 inserts a placeholder in that content segment. In some examples, the placeholder can be a notation that the entire outline section corresponding to the content requires human intervention or human composition. For example, the placeholder can be a temporary notation that content could not be generated for that section. In some examples, the placeholder can be a notation that content is missing or requires manual input. For example, in response to determining that the tuned AI model 305 has hallucinated names, dates, etc., the placeholder may be a notation that the user should manually input those names, dates, etc. in the output document 309.

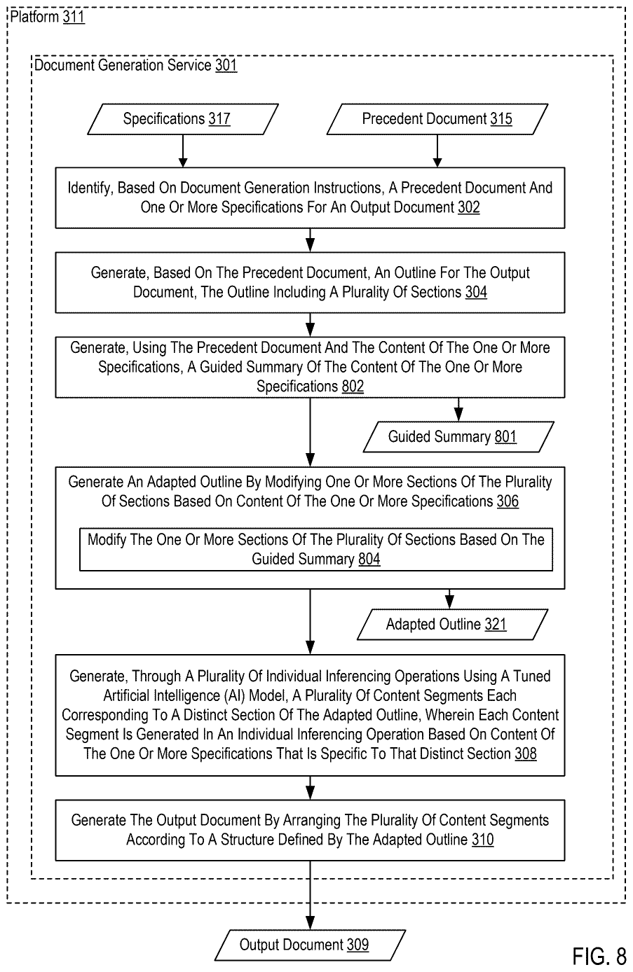

For further explanation, FIG. 8 sets forth another example method for an LLM-based document generation pipeline in accordance with at least one embodiment of the present disclosure. The method of FIG. 8 differs from the method of FIG. 3, at least in that the method of FIG. 8 also includes generating 802, using the precedent document 315 and the content of the one or more specifications 317, a guided summary 801 of the content of the one or more specifications 317. In some examples, the guided summary 801 represents a high-level overview of the content contained in the specifications 317. The overview is organized according to the structure of the precedent document 315. In some examples, the document generation service 301 leverages the tuned AI model 305 or another AI model to generate 802 the guided summary 801. For example, the document generation service 301 can prompt the tuned AI model 305 to generate a summary of the content included in the specifications. The generated summary can be token-limited to prevent coherence degradation associated with a long generation task. The document generation service 301 can also prompt the tuned AI model 305 to organize the generated summary according to the structure of the precedent document 315 to produce the guided summary 801. The guided summary 801 represents a synopsis of both the content and form for the output document 309.

In the example of FIG. 8, generating 308 the adapted outline 321 by modifying one or more sections of the plurality of sections to include a description based on the content of the one or more specifications 317 includes modifying 804 the one or more sections of the plurality of sections based on the guided summary 801. In some examples, the document generation service 301 utilizes the tuned AI model 305 or another AI model to generate the adapted outline 321 using the guided summary 801. Rather than utilizing all of the content in the specifications 317 to generate the adapted outline 321, the document generation service 301 utilizes the guided summary 801, which reduces the amount of input data used for inferencing. Accordingly, this reduces the amount of hardware resource utilization associated within the inferencing operation to generate the adapted outline 321. The generation of the adapted outline 321 based on the guided summary 801 is similar to the techniques discussed above. The summary of the content in the specifications 317 is used to inform the outline to be used for document generation. For example, the document generation service 301 can utilize the tuned AI model 305 or another AI model to determine, based on the guided summary 801 and/or the document generation instructions 307, which sections of the outline 319 are unnecessary. In another example, the document generation service 301 can utilize the tuned AI model 305 or another AI model to determine, based on the guided summary 801 and/or the document generation instructions 307, which sections of the outline 319 are missing. In yet another example, the document generation service 301 can generate the adapted outline 321 to include a content summary for one or more sections of the outline 319. For example, the content summary can be additional details of the type of content that pertains to a section of the outline 319 based on the guided summary 801. In some examples, the adapted outline 321 is generated as a data structure in a hierarchical structured format, such as JSON, YAML, or XML, where each section and subsection is represented as a nested structure.

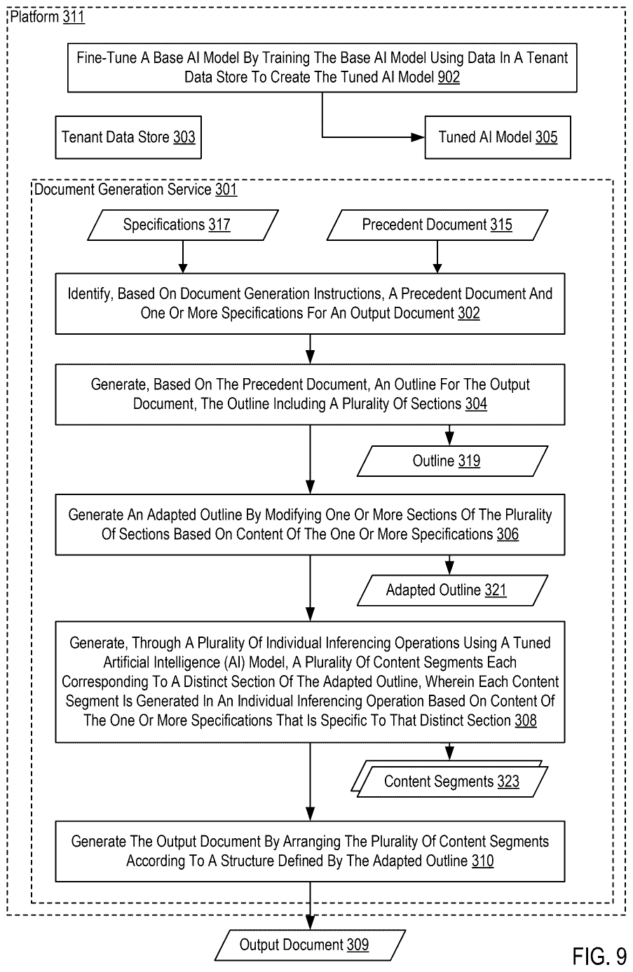

For further explanation, FIG. 9 sets forth another example method for an LLM-based document generation pipeline in accordance with at least one embodiment of the present disclosure. The method of FIG. 9 extends the method of FIG. 3 in that the method of FIG. 9 also includes fine-tuning 902 a base AI model by training the base AI model using data in a tenant data store 303 to create the tuned AI model 305. In some examples, the platform 311 fine-tunes the base language model by supervising a training of the base language model using the tenant-specific and domain specific data in the tenant data store 303. The objective of this fine-tuning process is to adapt the base language model to reflect the stylistic, tonal, and domain-specific characteristics present in the tenant's existing documents. These characteristics can include, but are not limited to, preferred terminology, technical depth, sentence structure, formatting conventions, and overall narrative style. The tenant documents used for fine-tuning can include various types of authored content, such as technical manuals, software documentation, knowledge base articles, or legal documents. These documents are collected from tenant data store 303 and preprocessed for fine-tuning the base language model. For example, preprocessing may include tokenization, normalization, and segmentation into training samples that meet the token length constraints of the underlying model.

In some examples, the base language model is fine-tuned based on a specific subset of documents within the tenant data store. For example, a base language model can be fine-tuned using software documentation, while another instance of the base language model can be fine-tuned using legal documents. As such, although only one tuned AI model 305 is depicted in FIG. 3, the document generation service 301 may employ multiple tuned AI models corresponding to various domain-specific tasks. In the case of document generation, the user may select a tuned AI model that is specific to a particular type of document to be generated, such as software docu-mentation or a legal document.

During the tuning process, the base model learns to predict the next token in each sequence based on preceding context, thereby internalizing the stylistic and structural patterns embedded in the tenant documents used as the training data. In some examples, the fine-tuning process does not utilize labeled input-output pairs, as the training data consists entirely of natural language sequences sampled from the tenant's own documents. In other examples, the fine-tuning process can use input-output pairs, such as an input specification and template paired with a ground-truth final document.

As a result of this fine-tuning process, the language model becomes more adept at generating text that reflects the tenant's established voice and domain norms. For example, when prompted with a task such as generating documentation, summaries, or correspondence, the model is more likely to produce output that aligns with the tenant's technical conventions, linguistic preferences, and organizational style guidelines. This approach enables domain adaptation of general-purpose language models while preserving tenant-specific linguistic characteristics, without requiring manual specification of formatting or structure.

As mentioned above, in some examples the platform 311 fine-tunes the base language model using sample inputs and ground truth documents based on those sample inputs. In this example, the platform 311 can employ a training dataset that includes sample instances of: a specification containing content for a final document, a precedent document such as a template or reference document, and a ground truth document that is a document derived from the specification and the precedent document. In such examples, the specification contains the factual or semantic information to be expressed, the precedent document specifies the desired structure and formatting of the resulting document, and the ground-truth document represents the final formatted output that combines the content with the structure prescribed by the template. The ground truth document can be, for example, a human authored document, a machine authored document that has been approved by a human, or a machine authored document that has passed an automated quality evaluation.

During fine-tuning based on input-output pairs, the base language model is trained in a supervised manner to generate the ground-truth document when presented with, for example, the corresponding content and template. In some examples, the content and template are tokenized and formatted with semantic markers. The base language model is trained to predict the next token in the output document given this input. The language model can employ an autoregressive transformer architecture and fine-tuning can be performed using a next-token prediction objective given the ground truth document. A loss is computed based on the output tokens and the ground truth document, and the loss is applied back to base model undergoing the training.

The present disclosure is directed to systems and methods that improve the functioning of computer systems in the field of automated document generation using artificial intelligence. Specifically, some of the disclosed techniques provide technological improvements in the operation and use of large language models for generating structured, domain-specific documents by segmenting the generation process based on outlines, thereby overcoming limitations such as context window constraints, coherence degradation, and token-based memory issues.

The disclosed approaches do not merely automate document creation using generic computing resources, but instead enhance the underlying AI-based generation process through a structured, modular inferencing pipeline that improves both performance and output quality in multi-section, tenant-specific documents. This architecture enables a document generation system to produce consistent and semantically accurate content across large-scale documents that exceed conventional context limitations, representing a concrete improvement in natural language generation systems and their application to enterprise documentation.

As such, the invention provides improvements to a various technological fields-particularly, machine learning-based document synthesis- and to the functionality of computing systems tasked with generating such documents, rather than merely performing a manual task using a computer. By generating each section of a document independently using an outline-guided process, the document generation system reduces processor usage, memory usage, and other resource demands associated with long content generation inferencing. By staying within the model's context window, truncation or unnecessary re-computation is reduced. This prevents model degradation caused by exceeding model capacity, thus reducing retries or quality checks that would otherwise consume extra cycles and demand more computational resources.

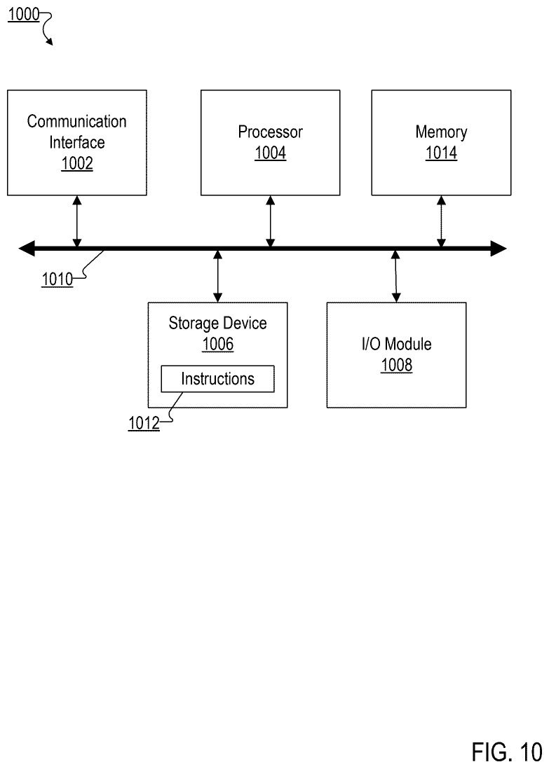

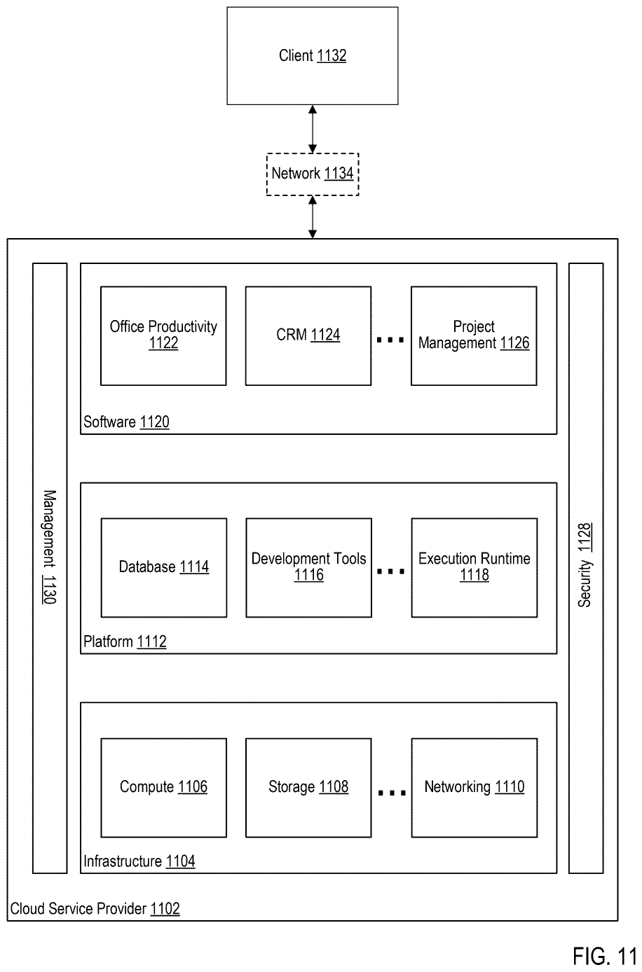

For further explanation, the sections included below provide some details regarding technologies that can be used to support LLM-based document generation pipeline in accordance with some examples. For example, FIG. 10 sets forth an example of a computing device that can be used for some portion of securing an operating system in accordance with some examples. As an additional example of technologies that can be used to support LLM-based document generation pipeline, FIG. 11 sets forth a block diagram of a cloud service provider 1102 service architecture in accordance with some examples of the present disclosure.

For further explanation, FIG. 10 illustrates an exemplary computing device 1000 that can be specifically configured to perform one or more of the processes described herein. As shown in FIG. 10, computing device 1000 can include a communication interface 1002, a processor 1004, a storage device 1006, an input/output (I/O) module 1008, and computer memory 1014 communicatively connected one to another via a communication infrastructure 1010. While an exemplary computing device 1000 is shown in FIG. 10, the components illustrated in FIG. 10 are not intended to be limiting. Additional or alternative components can be used in other examples. Components of computing device 1000 shown in FIG. 10 will now be described in additional detail.

Communication interface 1002 can be configured to communicate with one or more computing devices. Examples of communication interface 1002 include a wired network interface (such as a network interface card), a wireless network interface (such as a wireless network interface card), a modem, an audio/video connection, and any other suitable interface.

Processor 1004 generally represents any type or form of processing unit capable of processing data and/or interpreting, executing, and/or directing execution of one or more of the instructions, processes, and/or operations described herein. Processor 1004 can perform operations by executing computer-executable instructions 1012 including, for example, an application, software, code, and/or other executable data instance, which are stored in storage device 1006.

Storage device 1006 can include one or more data storage media, devices, or configurations and can employ any type, form, and combination of data storage media and/or device. For example, storage device 1006 can include any combination of non-volatile media and/or volatile media. Electronic data, including data described herein, can be temporarily and/or permanently stored in storage device 1006. For example, data representative of computer-executable instructions 1012 configured to direct processor 1004 to perform any of the operations described herein can be stored within storage device 1006. In some examples, data can be arranged in one or more databases residing within storage device 1006.

I/O module 1008 can include one or more I/O modules configured to receive user input and provide user output. I/O module 1008 can include any hardware, firmware, software, or combination thereof supportive of input and output capabilities. For example, I/O module 1008 can include hardware and/or software for capturing user input, including, a keyboard or keypad, a touchscreen component, a receiver (such as an RF or infrared receiver), motion sensors, and/or one or more input buttons.

I/O module 1008 can include one or more devices for presenting output to a user, including a graphics engine, a display, one or more output drivers (such as display drivers), one or more audio speakers, and one or more audio drivers. In certain examples, I/O module 1008 is configured to provide graphical data to a display for presentation to a user. The graphical data can be representative of one or more graphical user interfaces and/or any other graphical content as can serve a particular example. In some examples, any of the systems, computing devices, and/or other components described herein can be implemented by computing device 1000.

For further explanation and as an additional example of a supporting technology for LLM-based document generation pipeline, FIG. 11 sets forth a block diagram of a cloud service provider service architecture in accordance with some examples. The cloud service provider 1102 can deliver a variety of resources through a services-based consumption model where resources are consumed on-demand and as-a-service. Cloud service providers can provide services via cloud platforms such as, for example, Microsoft Azure™, Amazon Web Services (AWS)™, Google Cloud Platform (GCP)™, and others. In FIG. 11, the cloud service provider 1102 is accessed from a client device 1134 via a network 1132.

FIG. 11 depicts an embodiment where software 1120 is delivered as a service. Software-as-a-service (SaaS) is a model where software applications are delivered over the internet as-a-service. Rather than installing and maintaining software locally, users can access software via a web browser or other network connected interface, eliminating the need for complex software and hardware management on the client-side. In FIG. 11, as examples of software 1120 that can be delivered as-a-service, the illustrated embodiment includes office productivity 1122 software, customer relationship management (CRM) 1124 software, and project management 1126 software. The office productivity 1122 software can include applications designed to facilitate common business and personal tasks, including word processing applications, applications for spreadsheet creation, presentation design applications, and many others. The CRM 1124 software can include applications for managing a business organization's relationships and interactions with customers and potential customers. The project management 1126 software can include applications designed to help teams plan, organize, and manage projects efficiently by facilitating collaboration and tracking the progress of projects. Readers will appreciate that in other examples, other types of software can be delivered using a SaaS model.

FIG. 11 depicts an embodiment where platforms 1112 can be delivered as a service. Plat-form-as-a-service (PaaS) is a model that provides cloud customers with platform resources that they can use to develop, run, and manage applications without the complexity of such deploying and managing such infrastructure on their own. In FIG. 11, as examples of platform 1112 resources that can be delivered as-a-service, the illustrated embodiment includes database 1114 services, development tools 1116 services, and execution runtime 1118 services. The database 1114 services can be used to provide access to databases without management overhead for the user as the cloud service provider manages the provisioning, scaling, and maintenance of the databases. The development tools 1116 services can provide developers with tools to design, develop, test, and deploy applications without needing to manage the underlying infrastructure. The execution runtime 1118 services can provide environments where applications or other forms of computer program code can be executed, including services to scale the execution environment. Readers will appreciate that in other examples, other platform resources can be delivered using a PaaS model.

FIG. 11 depicts an embodiment where infrastructure 1104 can be delivered as a service. Infrastructure-as-a-Service (IaaS) is a model that provides virtualized computing resources over the internet, such that infrastructure such as servers, storage, networks, and others can be leased on demand rather than purchasing and maintaining physical hardware. In FIG. 11, as examples of infrastructure 1104 resources that can be delivered as-a-service, the illustrated embodiment includes compute 1106 services, storage 1108 services, and networking 1110 services. The compute 1106 services can be used to provide on-demand access to computational resources such as VMs, containers, and serverless functions, where the cloud service provider manages the provisioning, scaling, and maintenance of such resources. The storage 1108 services can provide storage resources that can be used to store and access data, without the need for customers to purchase and manage on-premises physical storage resources. The networking 1110 services can provide the ability to create and manage virtualized networking resources such as, for example, virtual private networks (VPNs), firewalls, load balancers, and more. Readers will appreciate that in other examples, other infrastructure resources can be delivered using a PaaS model.

The cloud service provider of FIG. 11 also provides management 1130 resources. The management 1130 resources can include, for example, tools and interfaces that enable customers to efficiently deploy, monitor, and manage, their cloud services. Such tools can include web-based management consoles, command-line interfaces (CLIs), APIs, automation tools, and other tools.

The cloud service provider of FIG. 11 also provides security 1128 resources. The security 1128 resources can include, for example, tools and services to help customers protect their cloud environments and ensure compliance with security standards. These tools and services can provide specific aspects of security, including identity and access management, network security, threat detection, compliance management, and others.

Readers will appreciate that many of the components described above can be delivered as services from a cloud service provider. For example, the virtual machines, containers, and pods described above can all be delivered via a cloud service provider. In other examples, other forms of compute resources can be used in place of the virtual machines or other compute resource. For example, AWS EC2 instances or other form of cloud compute instances can be utilized in place of the virtual machines.

Advantages and features of the present disclosure can be further described by the following statements:
1. A method comprising: identifying, based on document generation instructions, a precedent document and one or more specifications for an output document; generating, based on the precedent document, an outline for the output document, the outline including a plurality of sections; generating an adapted outline by modifying one or more sections of the plurality of sections based on content of the one or more specifications; generating, through a plurality of individual inferencing operations using a tuned artificial intelligence (AI) model, a plurality of content segments each corresponding to a distinct section of the adapted outline, wherein each content segment is generated in an individual inferencing operation based on content of the one or more specifications that is specific to that distinct section; and generating the output document by arranging the plurality of content segments according to a structure defined by the adapted outline.
2. The method of statement 1, wherein the tuned AI model is based on a base AI model that has been fine-tuned using a tenant data store associated with the user.
3. The method of statements 1-2, wherein generating the adapted outline by modifying one or more sections of the plurality of sections based on the content of the one or more specifications includes at least one of adding a section, removing a section, and inserting a description in a section.
4. The method of statements 1-3 further comprising: evaluating the outline based on one or more metrics to generate a quality rating; and regenerating at least a portion of the outline in response to determining that the outline fails to meet a threshold for the quality rating.
5. The method of statements 1-4 further comprising: evaluating the adapted outline based on one or more metrics to generate a quality rating; and regenerating at least a portion of the adapted outline in response to determining that that the adapted outline fails to meet a threshold for the quality rating.
6. The method of statements 1-5 further comprising: performing one or more quality checks for each content segment based on one or more of the document generation instructions, the one or more specifications, and the precedent document; and regenerating a content segment in response to determining that the content segment failed a quality check.
7. The method of statements 1-6 further comprising: determining that a threshold number of generations attempts for a particular section has been met; and inserting a placeholder in a portion of the output document corresponding to the particular section.
8. The method of statements 1-7 further comprising: generating, using the precedent document and the content of the one or more specifications, a guided summary of the content of the one or more specifications, wherein generating the adapted outline by modifying one or more sections of the plurality of sections to include a description based on the content of the one or more specifications includes modifying the one or more sections of the plurality of sections based on the guided summary.
9. The method of statements 1-8 further comprising: fine-tuning a base AI model by training the base AI model using data in a tenant data store to create the tuned AI model.
10. The method of statements 1-9, wherein: the tuned AI model is one of a plurality of tuned AI models each corresponding to a particular type of document and the document generation instructions indicate the tuned AI model for use in document generation.

The statements described herein provide a number of technical improvements to automated document generation for long or complex documents. Statement 1 introduces a method of automated document generation using a tuned AI model that improves automated document generation by generating an outline for a document, adapting the outline based on content, and utilizing independent inferencing operations to generate the output document one section at a time based on the adapted outline, thus mitigating against coherency degradation and improving the relevancy of the content that is generated.

Statement 2 describes that the tuned AI model is fine-tuned based on the tenant's own data, thus ensuring that the output document will be consistent with the style, voice, and level of detail of the tenant's documents. Statement 3 describes that the adaption of the outline includes adding, removing, or modifying sections of the outline to provide an outline that is more relevant to the content that is to be generated.

Statements 4-6 focus on evaluating the AI model's performance at each stage of the inferencing pipeline, including evaluating the outline generation (statement 3), evaluating the adapted outline generation (statement 4), and evaluating each content segment that is generated for the output document (statement 5). This ensures that quality is maintained throughout the pipeline, thus enhancing the quality of the output document. Statement 7 describes that the document generation system will utilize a placeholder in the output document to indicate that the document generation system could not generate content of sufficient quality for that portion of the document.

Statement 8 describes that the document generation system generates a guided summary of the content in the specifications, which reduces the size of the input to the tuned AI model when generating the adapted outline. Statements 9-10 focus on the fine-tuning of a base language model based on the tenant's data. Multiple tuned AI models can be used, where each model is trained for a domain-specific task.

Although some examples are described largely in the context of a system, method, or in some other way, readers will recognize that examples of the present disclosure can also take the form of a computer program product disposed upon computer readable storage media for use with any suitable processing system. Such computer readable storage media can be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the examples described in this specification are oriented to software installed and executing on computer hardware, nevertheless, alternative examples such as firmware or as hardware are well within the scope of the present disclosure.

Readers will appreciate that some examples are described in which computer program instructions are executed on computer hardware such as, for example, one or more computer processors. Readers will appreciate that in other examples, computer program instructions can be executed on virtualized computer hardware such as one or more virtual machines, in one or more containers, in one or more cloud computing instances, in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions can be provided in accordance with the principles described herein. The instructions, when executed by a processor of a computing device, can direct the processor and/or computing device to perform one or more operations, including one or more of the operations described herein. Such instructions can be stored and/or transmitted using any of a variety of known computer-readable media.

A non-transitory computer-readable medium as referred to herein can include any non-transitory storage medium that participates in providing data such as instructions that can be read and/or executed by a computing device such as by a processor of a computing device. For example, a non-transitory computer-readable medium can include any combination of non-volatile storage media and/or volatile storage media. Exemplary non-volatile storage media include read-only memory, flash memory, a solid-state drive, a magnetic storage device, like a hard disk, a floppy disk, magnetic tape, etc.), ferroelectric random-access memory (RAM), and an optical disc, such as a compact disc, a digital video disc, a Blu-ray disc, and the like. Exemplary volatile storage media include RAM.

One or more examples may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more examples are expressly described herein, other combinations of these features and functions are like-wise possible. The present disclosure is not limited by the particular examples disclosed herein and expressly incorporates these other combinations.

What is claimed is:

1. A method comprising:
identifying, based on document generation instructions, a precedent document and one or more specifications for an output document;
generating, based on the precedent document, an outline for the output document, the outline including a plurality of sections;
generating an adapted outline by modifying one or more sections of the plurality of sections based on content of the one or more specifications;
generating, through a plurality of individual inferencing operations using a tuned artificial intelligence (AI) model, a plurality of content segments each corresponding to a distinct section of the adapted outline, wherein each content segment is generated in an individual inferencing operation based on content of the one or more specifications that is specific to that distinct section; and
generating the output document by arranging the plurality of content segments according to a structure defined by the adapted outline.

2. The method of claim 1, wherein the tuned AI model is based on a base AI model that has been fine-tuned using a tenant data store.

3. The method of claim 1, wherein generating the adapted outline by modifying one or more sections of the plurality of sections based on the content of the one or more specifications includes at least one of adding a section, removing a section, and inserting a description in a section.

4. The method of claim 1 further comprising:
evaluating the outline based on one or more metrics to generate a quality rating; and
regenerating at least a portion of the outline in response to determining that the outline fails to meet a threshold for the quality rating.

5. The method of claim 1 further comprising:
evaluating the adapted outline based on one or more metrics to generate a quality rating; and
regenerating at least a portion of the adapted outline in response to determining that that the adapted outline fails to meet a threshold for the quality rating.

6. The method of claim 1 further comprising:
performing one or more quality checks for each content segment based on one or more of the document generation instructions, the one or more specifications, and the precedent document; and
regenerating a content segment in response to determining that the content segment failed a quality check.

7. The method of claim 6 further comprising:
determining that a threshold number of generations attempts for a particular section has been met; and
inserting a placeholder in a portion of the output document corresponding to the particular section.

8. The method of claim 1 further comprising:
generating, using the precedent document and the content of the one or more specifications, a guided summary of the content of the one or more specifications, wherein generating the adapted outline by modifying one or more sections of the plurality of sections to include a description based on the content of the one or more specifications includes modifying the one or more sections of the plurality of sections based on the guided summary.

9. The method of claim 1 further comprising:
fine-tuning a base AI model by training the base AI model using data in a tenant data store to create the tuned AI model.

10. The method of claim 1, wherein: the tuned AI model is one of a plurality of tuned AI models each corresponding to a particular type of document and the document generation instructions indicate the tuned AI model for use in document generation.

11. An apparatus for LLM-based document generation pipeline, comprising:
a memory; and
one or more processing devices, operatively coupled to the memory, the one or more processing devices configured to:
identify, based on document generation instructions, a precedent document and one or more specifications for an output document;
generate, based on the precedent document, an outline for the output document, the outline including a plurality of sections;
generate an adapted outline by modifying one or more sections of the plurality of sections based on content of the one or more specifications;
generate, through a plurality of individual inferencing operations using a tuned artificial intelligence (AI) model, a plurality of content segments each corresponding to a distinct section of the adapted outline, wherein each content segment is generated in an individual inferencing operation based on content of the one or more specifications that is specific to that distinct section; and
generate the output document by arranging the plurality of content segments according to a structure defined by the adapted outline.

12. The apparatus of claim 11, wherein the tuned AI model is based on a base AI model that has been fine-tuned using a tenant data store.

13. The apparatus of claim 11, wherein to generate the adapted outline, the one or more processing devices modify one or more sections of the plurality of sections based on the content of the one or more specifications by at least one of adding a section, removing a section, and inserting a description in a section.

14. The apparatus of claim 11, wherein the one or more processing devices are configured to:
evaluate the outline based on one or more metrics to generate a quality rating; and
regenerate at least a portion of the outline in response to determining that the outline fails to meet a threshold for the quality rating.

15. The apparatus of claim 11, wherein the one or more processing devices are configured to:
evaluate the adapted outline based on one or more metrics to generate a quality rating; and
regenerate at least a portion of the adapted outline in response to determining that that the adapted outline fails to meet a threshold for the quality rating.

16. The apparatus of claim 11, wherein the one or more processing devices are configured to:
perform one or more quality checks for each content segment based on one or more of the document generation instructions, the one or more specifications, and the precedent document; and
regenerate a content segment in response to determining that the content segment failed a quality check.

17. The apparatus of claim 16, wherein the one or more processing devices are configured to:
determine that a threshold number of generations attempts for a particular section has been met; and
insert a placeholder in a portion of the output document corresponding to the particular section.

18. The apparatus of claim 11, wherein the one or more processing devices are configured to:
generate, using the precedent document and the content of the one or more specifications, a guided summary of the content of the one or more specifications,
wherein to generate the adapted outline by modifying one or more sections of the plurality of sections to include a description based on the content of the one or more specifications, the one or more processing devices are configured to modify the one or more sections of the plurality of sections based on the guided summary.

19. The apparatus of claim 11 wherein the one or more processing devices are configured to:
fine-tune a base AI model by training the base AI model using data in a tenant data store to create the tuned AI model.

20. A method comprising:
generating, based on a precedent document, an outline for an output document, the outline including a plurality of sections, wherein at least one of the plurality of sections comprises a plurality of subsections;
generating an adapted outline by modifying one or more sections of the plurality of sections based on content of one or more specifications for the output document;
generating, through a plurality of individual inferencing operations using a tuned artificial intelligence (AI) model, a plurality of content segments each corresponding to a distinct section of the adapted outline, wherein each content segment is generated in an individual inferencing operation based on content of the one or more specifications that is specific to that distinct section;
performing one or more quality checks for each content segment based on one or more of the document generation instructions, the one or more specifications, and the precedent document;
regenerating at least one subsection of a content segment in response to determining that the content segment failed a quality check; and
generating the output document by arranging the plurality of content segments according to a structure defined by the adapted outline.
